(19) United States
(12) Patent Application Publication
(10) Pub. No.: US 2025/0298243 A1
(43) Pub. Date: Sep. 25, 2025

(54) AUGMENTED REALITY HEAD-UP DISPLAY (AR-HUD) SYSTEM WITH DOUBLE-SIDE EMISSIVE DISPLAY FUNCTION

(71) Applicant: AUO Corporation, Hsinchu City (TW)

(72) Inventors: Shih-Chi FAN-JIANG, Hsinchu City (TW); Seok-Lyul LEE, Hsinchu City (TW); Chan-Jui LIU, Hsinchu City (TW); Chia-Ting HSIEH, Hsinchu City (TW); Ching-Yao SHIH, Hsinchu City (TW)

(21) Appl. No.: 18/937,087

(22) Filed: Nov. 5, 2024

(30) Foreign Application Priority Data
Mar. 19, 2024 (TW) 113110141

(51) Int. Cl. G02B 27/01

(52) U.S. Cl. CPC G02B 27/0101

(57) ABSTRACT

An augmented reality head-up display (AR-HUD) system with a double-sided emissive display function is disclosed. The AR-HUD system includes an image generator, a plane mirror and a free-form mirror. The image generator emits a first incident light and a second incident light respectively to a first side and a second side opposite to each other. The plane mirror is disposed on the first side and configured to reflect the first incident light into a zeroth reflected light. The free-form mirror is disposed on the second side and configured to reflect the zeroth reflected light into a first reflected light and reflecting the second incident light into a second reflected light.

### CROSS-REFERENCE TO RELATED APPLICATION

This application claims the priority benefit of Taiwan application serial no. 113110141 filed on Mar. 19, 2024. The entirety of the above-mentioned patent applications is hereby incorporated by reference herein and made a part of this specification.

### TECHNICAL FIELD

The present invention relates to a head-up display, and more particularly to an augmented reality head-up display (AR-HUD) system with a double-side emissive display function.

### BACKGROUND

In general, an AR-HUD is a display that projects driving information such as Advanced Driver Assistance Systems (ADAS) messages, navigation, vehicle speed, speed limit indication, road warning, etc. in front of the driver's field of view through the optical projection technology, allowing the driver to focus his/her vision more on the road in front of the vehicle without needing to view a conventional instrument panel and navigation screen, so as to ensure driving safety.

However, the conventional AR-HUDs require a large number of optical components to achieve optical projection, resulting in an excessively large volume. For example, the conventional AR-HUD requires a volume of about 15 liters for a projection distance of 3 to 7 meters and has a short virtual image distance in front of the driver's field of view, seriously affecting its value in practical applications. Therefore, the conventional AR-HUDs need to be further improved.

### SUMMARY

In view of this, an AR-HUD system with a double-side emissive display function is proposed in the present invention to effectively solve the above-mentioned problems in the prior art.

According to an embodiment of the present invention, an AR-HUD system with a double-side emissive display function is provided. In this embodiment, the AR-HUD system includes an image generator, a plane mirror and a free-form mirror. The image generator is configured to emit a first incident light and a second incident light respectively to a first side and a second side opposite to each other. The plane mirror is disposed on the first side and configured to reflect the first incident light into a zeroth reflected light. The free-form mirror is disposed on the second side and configured to reflect the zeroth reflected light into a first reflected light and reflect the second incident light into a second reflected light.

In an embodiment, the image generator is a double-side emissive display, the image generator includes a plurality of light-emitting components, at least one first light-emitting component among the plurality of light-emitting components emits the first incident light to the first side, and at least one second light-emitting component among the plurality of light-emitting components emits the second incident light to the second side.

In an embodiment, the image generator includes a substrate and a reflective metal layer, the at least one first light-emitting component and the at least one second light-emitting component are both disposed on a first surface of the substrate facing the first side, the reflective metal layer is disposed above the at least one second light-emitting component, the at least one first light-emitting component emits the first incident light to the first side, and the at least one second light-emitting component emits the second incident light to the first side, and the second incident light is reflected by the reflective metal layer to the second side.

In an embodiment, the image generator includes a first light-emitting region, a second light-emitting region and a non-light-emitting region, the at least one first light-emitting component is disposed in the first light-emitting region, the at least one second light-emitting component is disposed in the second light-emitting region, and no light-emitting component is disposed in the non-light-emitting region.

In an embodiment, the first light-emitting region and the second light-emitting region are located at two ends of the image generator respectively, and the non-light-emitting region is located between the first light-emitting region and the second light-emitting region.

In an embodiment, the image generator includes a flexible substrate to have a curvature.

In an embodiment, the image generator is L-shaped or V-shaped.

In an embodiment, the image generator includes a flat panel, a first single-side emissive display and a second single-side emissive display, the first single-side emissive display is disposed on a first surface of the flat panel facing the first side to emit the first incident light to the first side, and the second single-side emissive display is disposed on a second surface of the flat panel facing the second side to emit the second incident light to the second side.

In an embodiment, the flat panel includes a graphite sheet or a metal material.

Compared with the prior art, the AR-HUD system proposed in the present invention has a double-side emissive display function. With the configuration of the plane mirror and the free-form mirror, driving information can be projected with a long virtual image distance in front of the vehicle driver's field of view through the double-side emissive display technology, thereby greatly reducing the volume and improving the driver's viewing experience, making the AR-HUD system more competitive in the market.

To further understand the features and technical contents of the present invention, please refer to the following detailed description and drawings of the present invention. However, the drawings provided are only for reference and explanation, and are not intended to limit the present invention.

### BRIEF DESCRIPTION OF THE DRAWINGS

FIG. 1 illustrates a schematic diagram of an AR-HUD with a double-side emissive display function in a first embodiment of the present invention.

FIG. 2A illustrates a schematic diagram of an image generator in a second embodiment of the present invention.

FIG. 2B illustrates an embodiment of the image generator in FIG. 2A.

FIG. 3A illustrates a schematic diagram of an image generator in a third embodiment of the present invention.

FIG. 3B illustrates an embodiment of the image generator in FIG. 3A.

FIG. 4A illustrates a schematic diagram of an image generator in a fourth embodiment of the present invention.

FIG. 4B illustrates an embodiment of the image generator in FIG. 4A.

FIG. 5 illustrates a schematic diagram of an AR-HUD with a double-side emissive display function in a fifth embodiment of the present invention.

FIG. 6 illustrates a schematic diagram of an image generator in a sixth embodiment of the present invention.

FIG. 7 illustrates a schematic diagram of an image generator in a seventh embodiment of the present invention.

### DETAILED DESCRIPTION

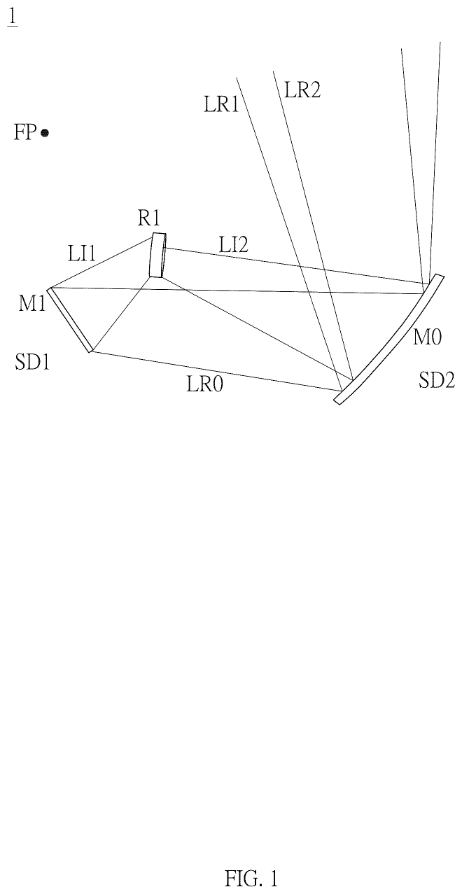

The following illustrates implementations disclosed by the present invention through specific embodiments and in conjunction with FIG. 1 to FIG. 7, and those skilled in the art can understand the advantages and effects of the present invention from the contents disclosed in this specification. However, the contents disclosed below are not intended to limit the scope of protection of the present invention, and those skilled in the art may implement the present invention with other different embodiments based on different viewpoints and applications without departing from the spirit of the conception of the present invention.

For the sake of clarity, the drawings of the present invention are all simplified schematic diagrams for illustrating the basic structure of the present invention. Therefore, the structure illustrated in the drawings of the present invention is not drawn to scale according to the shape and size of the structure in actual implementations. For example, the size of a specific component is enlarged for ease of illustration.

In addition, it should be understood that, when a component such as a layer, film, region, or substrate is referred to as being “on” or “connected to” another component, it may be directly on or connected to the another component, or an intermediate component may be present. In contrast, when a component is referred to as being “directly on” or “directly connected to” another component, there is no intermediate component present. As used herein, “connected” can refer to physical and/or electrical connection. Furthermore, “electrical connection” or “coupling” may mean that there is another component between the two components.

Unless otherwise defined, all terms (including technical and scientific terms) used herein have the same meaning as understood by those having ordinary skills in the art to which the present invention belongs. It will be further understood that the terms such as those defined in commonly used dictionaries should be interpreted as having meanings consistent with their meanings in the related art and the context of the present invention, and are not to be interpreted as having idealized or overly formal meanings, unless explicitly defined herein.

In addition, it should be understood that although the terms “first”, “second”, “third”, etc. may be used herein to describe various components, parts, regions, layers, and/or portions, these components, parts, regions, and/or portions should not be limited by these terms. These terms are only used to distinguish one component, part, region, layer, or portion from another component, part, region, layer, or portion. Therefore, a “first component”, a “first part”, a “first region”, a “first layer” or a “first portion” discussed below may be referred to as a second component, a second part, a second region, a second layer or a second portion without departing from the teachings herein.

### First Embodiment

An AR-HUD system with a double-side emissive display function in a first embodiment of the present invention will be described below in conjunction with FIG. 1.

As illustrated in FIG. 1, in this embodiment, an AR-HUD system 1 with a double-side emissive display function includes an image generator R1, a plane mirror M1 and a free-form mirror M0. The image generator R1 is configured to emit a first incident light LI1 and a second incident light LI2 respectively to a first side SD1 and a second side SD2 opposite to each other. The plane mirror M1 is located on the first side SD1 and the free-form mirror M0 is located on the second side SD2. The plane mirror M1 located on the first side SD1 is configured to reflect the first incident light LI1 incident on the first side SD1 into a zeroth reflected light LR0 directed to the second side SD2. The free-form mirror M0 located on the second side SD2 is configured to reflect the zeroth reflected light LR0 incident on the second side SD2 into a first reflected light LR1 and reflect the second incident light LI2 incident on the second side SD2 into a second reflected light LR2, so that the first reflected light LR1 and the second reflected light LR2 are projected to the front of the field of view corresponding to a focus F.

It should be noted that the AR-HUD system 1 projects driving information such as ADAS messages, navigation, vehicle speed, speed limit indication, road warning, etc. with a long virtual image distance in front of the field of view of the vehicle driver by using the first reflected light LR1 formed by the free-form mirror M0 reflecting the zeroth reflected light LR0 and the second reflected light LR2 formed by the free-form mirror M0 reflecting the second incident light LI2, so that the driver can view the driving information by looking straight ahead, thereby ensuring driving safety.

### Second Embodiment

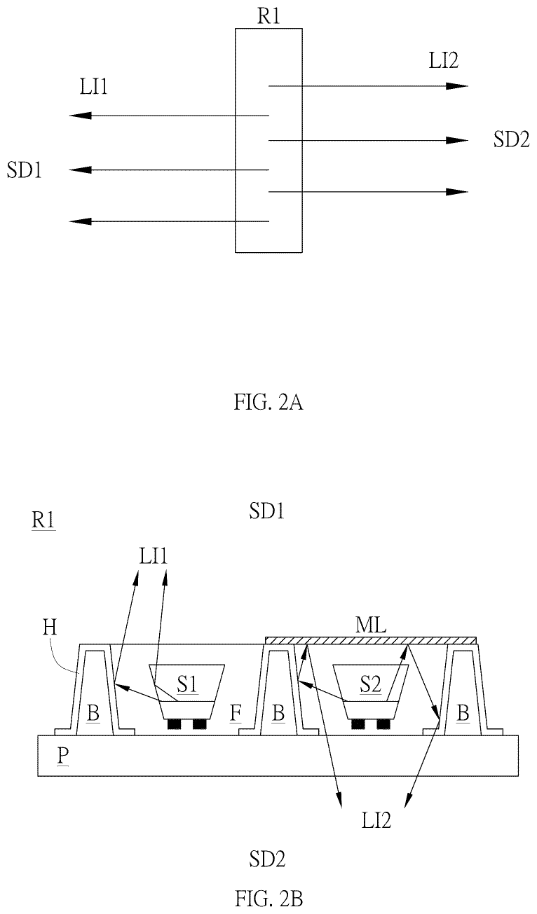

An image generator in a second embodiment of the present invention will be described below in conjunction with FIG. 2A and FIG. 2B.

FIG. 2A illustrates a schematic diagram of the image generator in this embodiment. As illustrated in FIG. 2A, the image generator R1 is a double-side emissive display, which can emit a first incident light LI1 and a second incident light LI2 respectively to a first side SD1 and a second side SD2 opposite to each other.

FIG. 2B illustrates an embodiment of the image generator R1 in FIG. 2A. As illustrated in FIG. 2B, the image generator R1 at least includes a first light-emitting component S1 and a second light-emitting component S2 adjacent to each other. The first light-emitting component S1 and the second light-emitting component S2 are both disposed on a first surface of a substrate P facing the first side SD1 and the first light-emitting component S1 and the second light-emitting component S2 are separated by a bank B. A highly reflective metal layer H is disposed on the bank B.

In practical applications, the first light-emitting component S1 and the second light-emitting component S2 may be micro light-emitting diodes (uLEDs), and the number of the first light-emitting component S1 and the number of the second light-emitting component S2 may be more than one, but not limited to this.

The first light-emitting component S1 is located in a space formed by two adjacent banks B. The space is filled with a light-transmitting material F and has an opening toward the first side SD1. The light emitted by the first light-emitting component S1 passes through the light-transmitting material F and is then reflected by the highly reflective metal layer H on the banks B to form a first incident light LI1, which is directed from the opening of the space toward the first side SD1.

The second light-emitting component S2 is located in a space formed by two adjacent banks B. The space is filled with the light-transmitting material F. Although the space also has an opening toward the first side SD1, the opening is shielded by a reflective metal layer ML. After passing through the light-transmitting material F, the light emitted by the second light-emitting component S2 is reflected by the highly reflective metal layer H on the banks B toward the first side SD1, and is then reflected by the reflective metal layer ML to form the second incident light LI2, which is directed to the second side SD2 after passing through the light-transmitting substrate P.

It should be noted that the image generator R1 illustrated in FIG. 2B is merely an embodiment of the image generator in the AR-HUD system of the present invention, but not limited to this.

### Third Embodiment

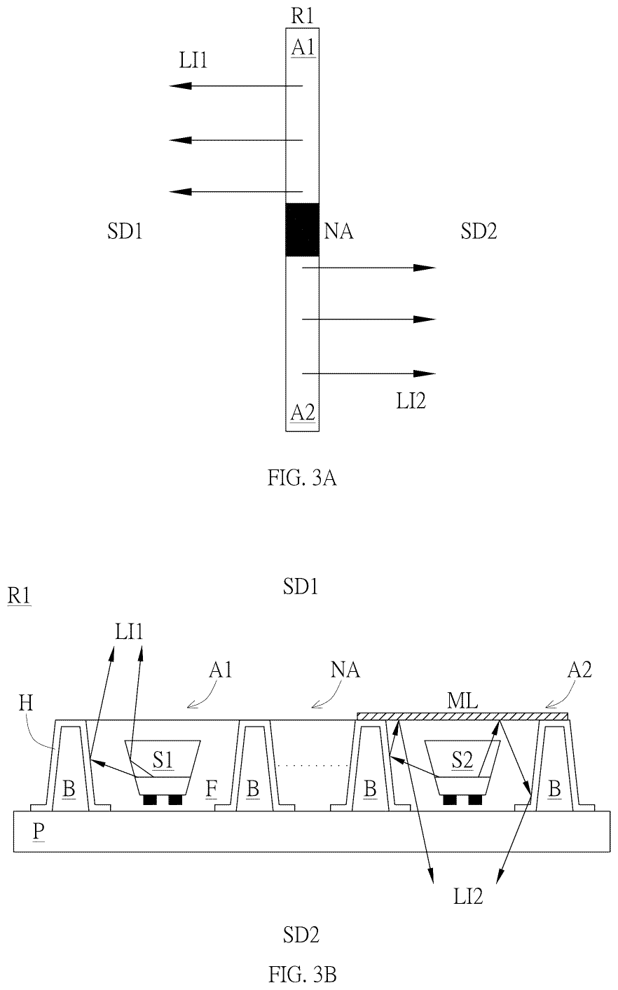

An image generator in a third embodiment of the present invention will be described below in conjunction with FIG. 3A and FIG. 3B.

FIG. 3A illustrates a schematic diagram of an image generator in this embodiment. As illustrated in FIG. 3A, an image generator R1 may include a non-light-emitting region NA located in the middle thereof, and a first light-emitting region A1 and a second light-emitting region A2 located on two sides thereof. The first light-emitting region A1 and the second light-emitting region A2 emit a first incident light LI1 and a second incident light LI2 respectively to a first side SD1 and a second side SD2 opposite to each other.

FIG. 3B illustrates an embodiment of the image generator R1 in FIG. 3A. As illustrated in FIG. 3B, the image generator R1 includes a first light-emitting component S1 and a second light-emitting component S2. The first light-emitting component S1 and the second light-emitting component S2 are both disposed on a first surface of a substrate P facing the first side SD1 and the first light-emitting component S1 and the second light-emitting component S2 are separated by a bank B. A highly reflective metal layer H is disposed on the bank B. The first light-emitting component S1 is located in the first light-emitting region A1 and the second light-emitting component S2 is located in the second light-emitting region A2. No light-emitting component is disposed in the non-light-emitting region NA between the first light-emitting region A1 and the second light-emitting region A2.

In practical applications, the first light-emitting component S1 and the second light-emitting component S2 may be uLEDs, the number of the first light-emitting component S1 and the number of the second light-emitting component S2 may be more than one, and the size and position of the non-light-emitting region NA may be determined according to actual needs, but not limited to this.

The first light-emitting component S1 is located in a space formed by two adjacent banks B. The space is filled with a light-transmitting material F and has an opening toward the first side SD1. The light emitted by the first light-emitting component S1 passes through the light-transmitting material F and is then reflected by the highly reflective metal layer H on the banks B to form a first incident light LI1, which is directed from the opening of the space toward the first side SD1.

The second light-emitting component S2 is located in a space formed by two adjacent banks B. The space is filled with the light-transmitting material F. Although the space also has an opening toward the first side SD1, the opening is shielded by a reflective metal layer ML. After passing through the light-transmitting material F, the light emitted by the second light-emitting component S2 is reflected by the highly reflective metal layer H on the banks B toward the first side SD1, and is then reflected by the reflective metal layer ML to form the second incident light LI2, which is directed to the second side SD2 after passing through the light-transmitting substrate P.

It should be noted that the image generator R1 illustrated in FIG. 3B is merely an embodiment of the image generator in the AR-HUD system of the present invention, but not limited to this.

### Fourth Embodiment

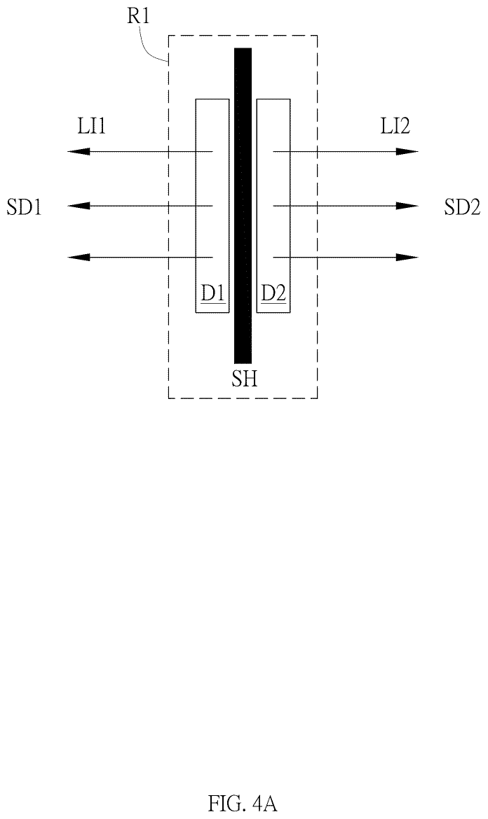

An image generator in a fourth embodiment of the present invention will be described below in conjunction with FIG. 4A and FIG. 4B.

FIG. 4A illustrates a schematic diagram of an image generator in this embodiment. As illustrated in FIG. 4A, an image generator R1 is formed by respectively disposing two single-side emissive displays D1 and D2 on a first surface of a flat panel SH facing a first side SD1 and a second surface of the flat panel SH facing a second side SD2 so as to emit a first incident light LI1 and a second incident light LI2 respectively to the first side SD1 and the second side SD2 opposite to each other.

FIG. 4B illustrates an embodiment of the image generator R1 in FIG. 4A.

The first single-side emissive display D1 is disposed on the first surface of the flat panel SH facing the first side SD1. The first single-side emissive display D1 at least includes a first light-emitting component S1 and a second light-emitting component S2 adjacent to each other. The first light-emitting component S1 and the second light-emitting component S2 are both disposed on a first surface of a first substrate P1 facing the first side SD1 and the first light-emitting component S1 and the second light-emitting component S2 are separated by a bank B. A highly reflective metal layer H is disposed on the bank B.

In practical applications, the first light-emitting component S1 and the second light-emitting component S2 may be uLEDs, the number of the first light-emitting component S1 and the number of the second light-emitting component S2 may be more than one, and the flat panel SH may include, for example, a graphite sheet or a metal material for heat dissipation, but not limited to this.

The first light-emitting component S1 is located in a space formed by two adjacent banks B. The space is filled with a light-transmitting material F and has an opening toward the first side SD1. After passing through the light-transmitting material F, light emitted by the first light-emitting component S1 is reflected by the highly reflective metal layer H on the banks B to form a first incident light LI1, which is directed from the opening of the space toward the first side SD1. Similarly, the second light-emitting component S2 also emits the first incident light LI1 to the first side SD1.

The second single-side emissive display D2 is disposed on a second surface of the flat panel SH facing the second side SD2. The second single-side emissive display D2 at least includes a third light-emitting component S3 and a fourth light-emitting component S4 adjacent to each other. The third light-emitting component S3 and the fourth light-emitting component S4 are both disposed on a second surface of a second substrate P2 facing the second side SD2 and the third light-emitting component S3 and the fourth light-emitting component S4 are separated by the bank B. A highly reflective metal layer H is disposed on the bank B.

In practical applications, the third light-emitting component S3 and the fourth light-emitting component S4 may be uLEDs, and the number of the first light-emitting component S1 and the number of the second light-emitting component S2 may be more than one, but not limited to this.

The third light-emitting component S3 is located in a space formed by two adjacent banks B. The space is filled with the light-transmitting material F and has an opening toward the second side SD2. After passing through the light-transmitting material F, the light emitted by the third light-emitting component S3 is reflected by the highly reflective metal layer H on the banks B to form a second incident light LI2, which is directed from the opening of the space to the second side SD2. Similarly, the fourth light-emitting component S4 also emits the second incident light LI2 to the second side SD2.

It should be noted that the image generator R1 illustrated in FIG. 4B is merely an embodiment of the image generator in the AR-HUD system of the present invention, but not limited to this.

### Fifth Embodiment

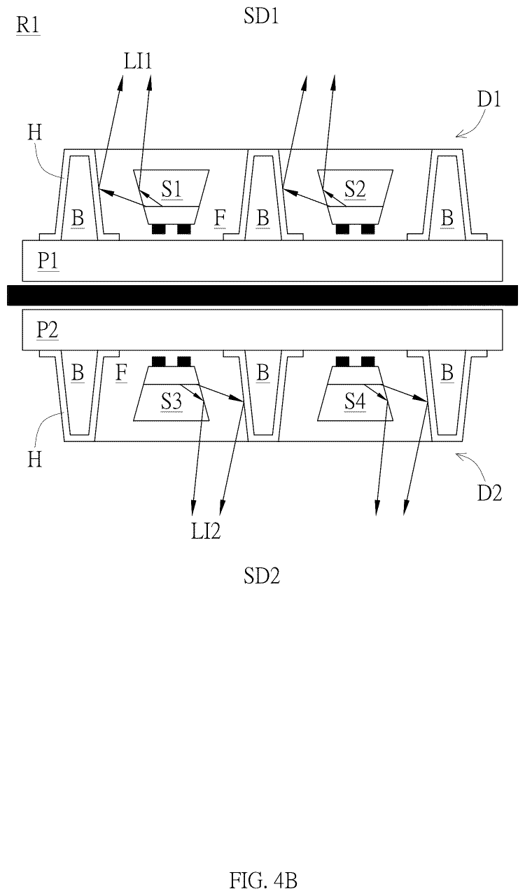

An AR-HUD system with a double-side emissive display function in a fifth embodiment of the present invention will be described below in conjunction with FIG. 5.

As illustrated in FIG. 5, in this embodiment, an AR-HUD system 5 with a double-side emissive display function includes an image generator R1 having a curvature, a plane mirror M1 and a free-form mirror M0. The image generator R1 having the curvature is configured to emit a first incident light LI1 and a second incident light LI2 respectively to a first side SD1 and a second side SD2 opposite to each other. The plane mirror M1 is located on the first side SD1 and the free-form mirror M0 is located on the second side SD2. The plane mirror M1 located on the first side SD1 is configured to reflect the first incident light LI1 incident on the first side SD1 into a zeroth reflected light LR0, which is directed to the second side SD2. The free-form mirror M0 located on the second side SD2 is configured to reflect the zeroth reflected light LR0 incident on the second side SD2 into a first reflected light LR1 and reflect the second incident light LI2 incident on the second side SD2 into a second reflected light LR2, so that the first reflected light LR1 and the second reflected light LR2 are projected to the front of the field of view corresponding to a focus F.

It should be noted that the AR-HUD system 5 projects driving information such as ADAS messages, navigation, vehicle speed, speed limit indication, road warning, etc. with a long virtual image distance in front of the field of view of the vehicle driver by using the first reflected light LR1 formed by the free-form mirror M0 reflecting the zeroth reflected light LR0 and the second reflected light LR2 formed by the free-form mirror M0 reflecting the second incident light LI2, so that the driver can view the driving information by looking straight ahead, thereby ensuring driving safety.

### Sixth Embodiment

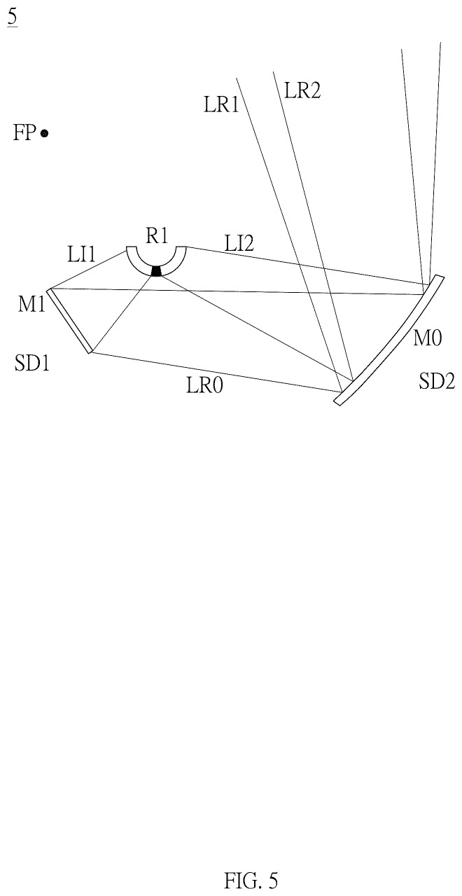

An image generator in a sixth embodiment of the present invention will be described below in conjunction with FIG. 6.

FIG. 6 illustrates a schematic diagram of the image generator in this embodiment. As illustrated in FIG. 6, a U-shaped image generator R1 includes a non-light-emitting region NA in the middle thereof, and a first light-emitting region A1 and a second light-emitting region A2 on two sides thereof. The first light-emitting region A1 and the second light-emitting region A2 emit a first incident light LI1 and a second incident light LI2 respectively to a first side SD1 and a second side SD2 opposite to each other.

In practical applications, the image generator R1 may include a flexible substrate to have a curvature (e.g., U-shaped), and the size and position of the non-light-emitting region NA may be determined according to actual needs, but the present invention is not limited thereto.

### Seventh Embodiment

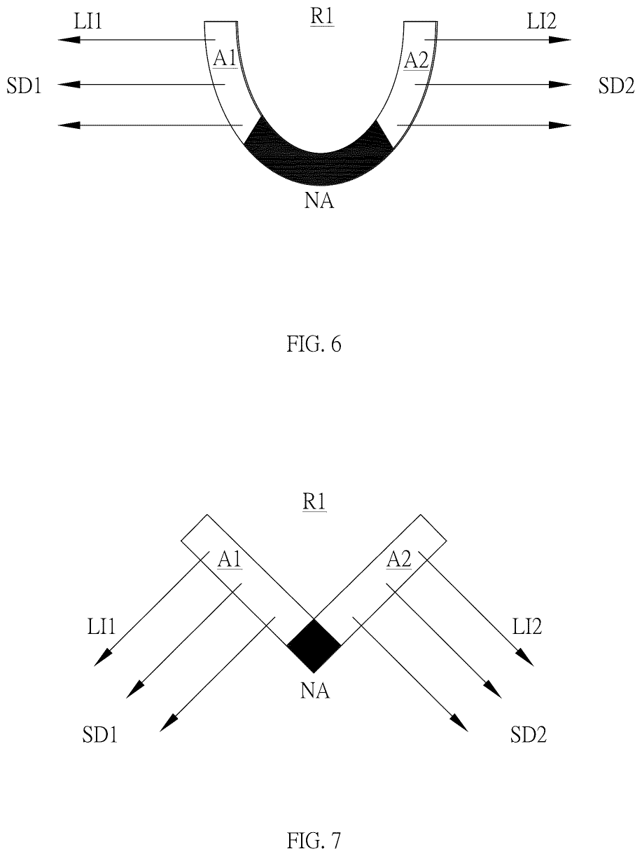

An image generator in a seventh embodiment of the present invention will be described below in conjunction with FIG. 7.

FIG. 7 illustrates a schematic diagram of the image generator in this embodiment. As illustrated in FIG. 7, an L-shaped image generator R1 includes a first light-emitting region A1, a second light-emitting region A2 and a non-light-emitting region NA located at an intersection of the first light-emitting region A1 and the second light-emitting region A2. The first light-emitting region A1 and the second light-emitting region A2 emit a first incident light LI1 and a second incident light LI2 respectively to a first side SD1 and a second side SD2 opposite to each other.

In practical applications, the image generator R1 may be of an L-shape or a V-shape formed by two substrates, and the size and position of the non-light-emitting region NA may be determined according to actual needs, but not limited to this.

Compared with the prior art, the AR-HUD system proposed in the present invention has a double-side emissive display function. With the configuration of the plane mirror and the free-form mirror, driving information can be projected with a long virtual image distance in front of the vehicle driver's field of view through the double-side emissive display technology, thereby greatly reducing the volume and improving the driver's viewing experience, making the AR-HUD system more competitive in the market.

The contents disclosed above are merely feasible embodiments of the present invention, and are not intended to limit the scope of the claims of the present invention. Therefore, all equivalent technical changes made based on the specification and the drawings of the present invention fall within the scope of the claims of the present invention.

What is claimed is:

1. An augmented reality head-up display (AR-HUD) system with a double-side emissive display function, comprising:
an image generator, configured to emit a first incident light and a second incident light respectively to a first side and a second side opposite to each other;
a plane mirror, disposed on the first side and configured to reflect the first incident light into a zeroth reflected light; and
a free-form mirror, disposed on the second side and configured to reflect the zeroth reflected light into a first reflected light and reflect the second incident light into a second reflected light.

2. The AR-HUD system according to claim 1, wherein the image generator is a double-side emissive display, the image generator comprises a plurality of light-emitting components, at least one first light-emitting component among the plurality of light-emitting components emits the first incident light to the first side and at least one second light-emitting component among the plurality of light-emitting components emits the second incident light to the second side.

3. The AR-HUD system according to claim 2, wherein the image generator comprises a substrate and a reflective metal layer, the at least one first light-emitting component and the at least one second light-emitting component are both disposed on a first surface of the substrate facing the first side, the reflective metal layer is disposed above the at least one second light-emitting component, the at least one first light-emitting component emits the first incident light toward the first side, and the at least one second light-emitting component emits the second incident light toward the first side, and the second incident light is reflected by the reflective metal layer to the second side.

4. The AR-HUD system according to claim 2, wherein the image generator comprises a first light-emitting region, a second light-emitting region, and a non-light-emitting region, the at least one first light-emitting component is disposed in the first light-emitting region, the at least one second light-emitting component is disposed in the second light-emitting region, and no light-emitting component is disposed in the non-light-emitting region.

5. The AR-HUD system according to claim 4, wherein the first light-emitting region and the second light-emitting region are located at two ends of the image generator respectively, and the non-light-emitting region is located between the first light-emitting region and the second light-emitting region.

6. The AR-HUD system according to claim 4, wherein the image generator comprises a flexible substrate to have a curvature.

7. The AR-HUD system according to claim 4, wherein the image generator is L-shaped or V-shaped.

8. The AR-HUD system according to claim 1, wherein the image generator comprises a flat panel, a first single-side emissive display and a second single-side emissive display, the first single-side emissive display is disposed on a first surface of the flat panel facing the first side to emit the first incident light to the first side, and the second single-side emissive display is disposed on a second surface of the flat panel facing the second side to emit the second incident light to the second side.

9. The AR-HUD system according to claim 8, wherein the flat panel comprises a graphite sheet or a metal material.
